(19) United States
(12) Patent Application Publication
(10) Pub. No.: US 2019/0202557 A1
(43) Pub. Date: Jul. 4, 2019

(54) PIZZA COOKING DELIVERY DRONE

(71) Applicant: Walmart Apollo, LLC, Bentonville, AR (US)

(72) Inventors: John S. MEREDITH, Bentonville, AR (US); Timothy J. BURLESON, Bentonville, AR (US); Kimberly D. CALDWELL, Rogers, AR (US); Todd MATTINGLY, Bentonville, AR (US)

(73) Assignee: Walmart Apollo, LLC, Bentonville, AR (US)

(21) Appl. No.: 16/226,080

(22) Filed: Dec. 19, 2018

Related U.S. Application Data
(60) Provisional application No. 62/611,762, filed on Dec. 29, 2017.

(51) Int. Cl. B64C 39/02; A21B 1/52; A21B 1/42; A21D 13/41; B64D 11/00

(52) U.S. Cl. CPC B64C 39/024; A21B 1/52; A21B 1/42; B64C 2201/141; B64D 11/0007; B64C 2201/128; A21D 13/41

(57) ABSTRACT

An unmanned vehicle for cooking and delivering food may include a housing. The housing may include an oven having at least one heating element, a conveyor inside the oven. The conveyor may be configured to support food. A tambour door may be coupled between the oven and a delivery area of the housing. A delivery door may be configured to seal the delivery area from an area outside of the housing. The oven may be configured to cook food during a delivery time of the drone and the drone may be configured to deliver the food to a delivery location. The process from ordering to delivery of the food item may be tracked using blockchains.

### CROSS-REFERENCE TO RELATED APPLICATIONS

This application claims priority to U.S. Provisional Patent Application No. 62/611,762, filed Dec. 29, 2017, the contents of which are incorporated herein in their entirety.

### TECHNICAL FIELD OF THE INVENTION

The present application relates to an autonomous vehicle for cooking and delivering food. More specifically, the present application relates to a drone for cooking pizza in flight to a delivery location.

### BACKGROUND OF THE INVENTION

Currently, food delivery is restricted to locations accessible by car in order for a restaurant employee to deliver the take-out food, such as pizza, to the customer. A customer may order take-out food on a computer or other mobile device and enter in a delivery address. The delivery address entered must be a physical mailing address to which a car has access. Thus a need exists for a delivery vehicle which can deliver take-out food to any location, including those not accessible by car while still providing a hot and ready to eat take-out food.

### BRIEF SUMMARY OF THE INVENTION

According to an embodiment of the present disclosure, an unmanned vehicle for cooking and delivering food may include a housing, an oven inside the housing, the oven having at least one heating element, a conveyor inside the oven, the conveyor configured to support food, a tambour door coupled between the oven and a delivery area of the housing, and a delivery door configured to seal the delivery area from an area outside of the housing. The oven may be configured to cook food during a delivery time of the unmanned vehicle, and wherein the unmanned vehicle is configured to deliver the food to a delivery location.

According to an embodiment of the present disclosure, a method for cooking food during aerial transport of the food may include providing an unmanned aerial vehicle, the unmanned aerial vehicle having a housing comprising an oven and a delivery area, loading a food item into the oven of the unmanned aerial vehicle at a first location, navigating the unmanned aerial vehicle to a second location, cooking the food item in the oven during the navigating to the second location, landing the unmanned aerial vehicle at the second location, conveying the food item on a conveyor from the oven to a box in the delivery area, and opening a delivery door of the unmanned aerial vehicle to deliver the box to the second location.

### BRIEF DESCRIPTION OF DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 shows a schematic view of a drone, according to an embodiment of the present disclosure;

FIG. 2 shows a schematic view of a drone, according to an embodiment of the present disclosure;

FIG. 3 shows a schematic of a the drone of FIG. 1 coupled to an unmanned aerial vehicle, according to an embodiment of the present disclosure; and

FIG. 4 shows a flow diagram for tracking of a delivery time, according to an embodiment of the present disclosure.

### DETAILED DESCRIPTION OF THE INVENTION

Embodiments of the invention are discussed in detail below. In describing embodiments, specific terminology is employed for the sake of clarity. However, the invention is not intended to be limited to the specific terminology so selected. A person skilled in the relevant art would recognize that other equivalent parts can be employed and other methods developed without departing from the spirit and scope of the invention. All references cited herein are incorporated by reference as if each had been individually incorporated.

The present disclosure relates to a drone to cook food during transit. More specifically, the present disclosure relates to delivering take-out food, such as pizza, with a drone. The drone may cook and deliver the take-out food at the same time. The drone may be programmed to consider cooking time and travel time to deliver hot and ready to eat take-out food to the customer. The drone may deliver the take-out food to any location, including beaches, boats, sporting events, concerts, picnics, houses, etc. The drone may be preloaded with take-out food and parked in a public, community location, allowing the user to access these “remote” drone locations outside of the drone's home location. The drone of the present disclosure allows for a variety of food items to be delivered to any number of locations.

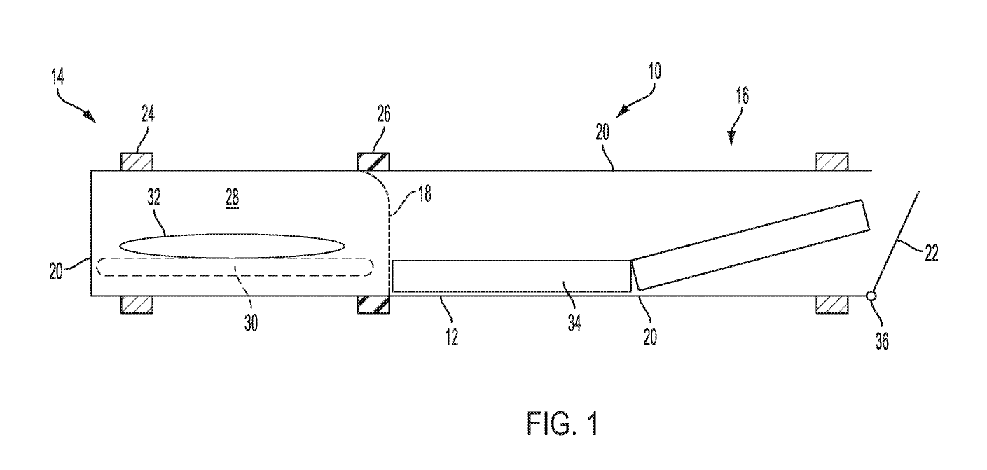

Referring to FIG. 1, a schematic view of a drone 10 is shown. The drone 10 may be any autonomous vehicle, including an unmanned aerial vehicle. The drone 10 may include a housing 12 divided into two areas, a cooking area 14 and a delivery area 16. The cooking area 14 may be separated from the delivery area 16 by a door 18. The housing 12 may include a plurality of walls 20 and a delivery door 22. The housing 12 may include physical connections 24 and power and/or control connections 26.

The cooking area 14 may include one or more ovens 28. The oven 28 may be an electric oven. The oven 28 may be battery powered. The oven 28 may include an onboard thermometer (not depicted), either physical or remote. The thermometer may ensure the food item 32 has reached a safe minimum temperature for consumption. The oven 28 may include one or more heating elements (not depicted). The heating elements may be located on a top, bottom, and/or side wall of the oven 28. For example, a first heating element may be located on the interior surface of the top of the oven 28 and a second heating element may be located on the interior surface of the bottom of the oven 28. The heating elements may be located for the particular food item to be cooked. The one or more heating elements may be any heating elements which are capable of heating the oven 28 to any temperature, for example, from 0° F. to 500° F. The one or more heating elements may be any heating elements which are capable of holding the oven 28 at a constant temperature and are a capable of being electrically controlled by a controller, to be explained in more detail to follow. The portion of the housing 12 comprising the cooking area 14 may include insulation to contain the heat of the oven 28 within the cooking area 14. The interior walls of the cooking area 14 may further include a firewall. Although not depicted, the cooking area 14 may also include a cooling device to cool the food item to a desirable temperature and/or to provide a safety back-up in the case of oven malfunction.

The cooking area 14 may include a conveyor 30. The conveyor 30 may be any type of conveyor capable of transporting food from the cooking area 14 to the delivery area 16. For example, the conveyor 30 may include a conveyor belt, conveyor rollers, or other type of conveyor or moving track. In operation, a food item 32, such as an uncooked pizza, may be placed on the conveyor 30 through a loading door (not depicted) located in the housing 12. After the oven 28 has cooked the food item 32, the conveyor 30 may be actuated to move the now cooked food item 32 to the delivery area 16, particularly, to a container 34, located in the delivery area 16. The conveyor 30 may be actuated by a controller, to be explained in more detail to follow.

As previously mentioned, the cooking area 14 may have a loading door (not depicted). The loading door may be located on a top, bottom, or side surface of the housing 12 in the cooking area 14. The loading door may allow access from an exterior of the housing 12 into the cooking area 14, and specifically, the oven 28. The loading door may allow a user to place a food item 32 into the oven 28. The loading door may be locked once food is placed within the oven 28 to prevent unauthorized access to the oven 28. The locked loading door may ensure safety of a customer by preventing the customer from accessing the oven when the drone 10 delivers the food item 32. Although the food item 32 is described and depicted as a pizza, it may be understood that any food item may be placed in the oven 28 to be cooked in the cooking area 14.

The cooking area 14 may be separated from the delivery area 16 by a door 18. The door 18 may be a tambour door or other track mounted door. The door 18 may include an insulating material and/or a firewall material. The door 18 may be in a normally closed position, such that the cooking area 14 and oven 28 are sealed from the delivery area 16. The door 18 may be actuated or controlled to raise when delivery of the food item 32 from the oven 28 to the container 34 is desired. The door 18 may be actuated or controlled to lower after the conveyor 30 moves the food item 32 into the delivery area 16. The door 18 may be actuated by a controller, to be explained in more detail to follow.

The delivery area 16 may include the delivery door 22. The delivery door 22 may be any door which allows the delivery area 16 to be accessed by a customer to retrieve the container 34 with the cooked food item 32. The delivery door 22 may be hinged at a connection 36 at the bottom of the housing 12. Alternatively, the hinged connection 36 may be at the top of the housing 12. The delivery door 22 may be latched such that the door remains closed until unlatched by the customer or the controller. Although a hinged delivery door 22 is shown and described, it will be understood that other types of doors may be provided, such as sliding doors, bi-fold doors, tambour doors, or other types of doors.

The delivery area 16 may include the container 34 for receiving the cooked food item 32. In the exemplary embodiment, where the food item 32 is a pizza, the container 34 may be a pizza box. However, it will be understood that the container 34 may be shaped and sized to accommodate any food item 32. The container 34 may have a hinged top. The container 34 may be placed in the delivery area 16 with the top in an open position, such that when the food item 32 is moved from the cooking area 14 to the delivery area 16, it may be placed directly from the conveyor 30 into the container 34. The delivery area 16 may include a device for closing the hinged top or placing a separate lid or top on the container 34. Alternatively, the customer may close the container 34 by closing the hinged top or placing a separate lid or top on the container 34 when the customer accesses the delivery area 16 through the delivery door 22.

As previously mentioned, the drone 10 may include physical connections 24 and power and control connections 26. The physical connections 24 may connect the housing 12 to a second housing 12 with a second cooking area 14 and a second delivery area 16. In this manner, the physical connections 24 may allow for the drone 10 to be modular such that any number of housings 12 may be stacked to accommodate more than one food item for one or more customers. The physical connections 24 may also allow for the drone 10 to be connected to the necessary thrust components to allow for the ground, aerial, or aqua travel of the drone 10. The power and/or control connections 26 may provide power and control to one or more components of the drone 10. For example, the power and/or control connections 26 may provide power and/or control to the oven 28, conveyor 30, door 18, delivery door 22, and controller (not depicted). One or more controllers may be provided with the drone 10 to control the cooking process, the thrust, acceleration, and/or directional control of the drone 10, the actuation of the mechanical components such as the door 18, delivery door 22, and/or conveyor 30, and the temperature and timing of the oven 28, etc.

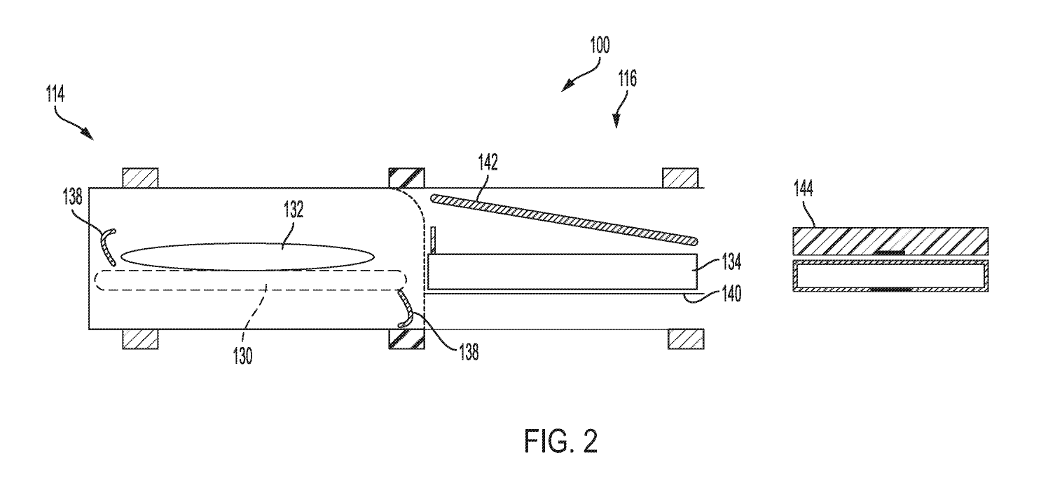

Referring now to FIG. 2, a schematic of a drone 100 is shown. It may be appreciated that the drone 100 may the same or similar to the drone 10. It may also be appreciated that components for which reference numerals are omitted may be the same or similar to the components present in the drone 10. The drone 100 may have a cooking area 114 and a delivery area 116 which may be the same or similar to the cooking area 14 and the delivery area 16 of drone 10, respectively.

The cooking area 114 may include a conveyor 130 which may be the same or similar as conveyor 30. The conveyor 130 may include projecting members 138. The projecting members 138 may extend from the conveyor 130 and may be fixed to the conveyor 130 such that they translate with the motion of the conveyor 130. The projecting members 138 may be substantially straight or may have a curved upper surface. The projecting members 138 may contact an edge of the food item 132 and ensure that when the food item 132 reaches the end of the conveyor 130, the food item 132 forces the food item 132 to completely leave the conveyor 130 and enter the container 134. Although two projecting members 138 are depicted, it may be appreciated that only one or alternatively two or more projecting members 138 may be provided.

Alternative manners to move the food item 132 from the conveyor 130 to the container 134 may be included. For example, a device may be included that is coupled to the inner surface of the wall 20. The device may move or actuate in a lateral direction across the conveyor, thus pushing the food item 132 off the conveyor 130 and into the container 134. In such an embodiment, the conveyor 130 may be stationary as the movement of the food item 132 is achieved with the sliding device. In other embodiments, a device to pull, slide, or otherwise move the food item 132 from the oven 28 to the container 134 may be provided.

The delivery area 116 may include a platform 140 on which the container 134 sits. In this manner, the food item 132 and the container 134 may be at the same level. It may be appreciated, that including the platform 140 may facilitate moving the food item 132 into the container 134. The delivery area 116 may also include a tapered roof 142. The tapered roof 142 may be a slanted, sloped, or otherwise tapered projection. The tapered roof 142 may be located such that as the container 134 is removed from the delivery area 116, a cover 144 is closed or further pressed to ensure the cover 144 is closed. The cover 144 may be a separate piece of cardboard or plastic. The cover 144 may slide down in a track to close the container 134. The delivery area 116 may include a device (not depicted) which may push or otherwise assist moving the container 134 through the delivery door and out of the delivery area 116.

As may be appreciated from the foregoing disclosure, the components of the drone 10 and the drone 100 may be interchanged. That is, components of the drone 100 may be included in the drone 10 and vice versa. For example, the drone 10 may include projecting members 138 and/or platform 140. The door 18, delivery door 22, controller, oven 28, physical connections 24, and/or power and control connections 26 may be provided in the drone 100.

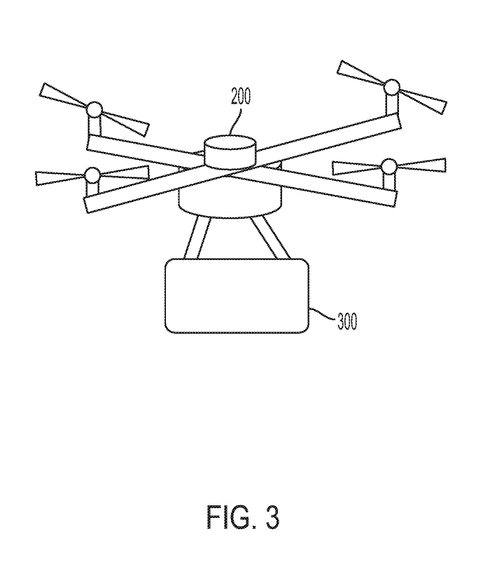

FIG. 3 depicts an unmanned aerial vehicle (UAV) 200 connected to a modular component 300. The modular component may include any or all of the components of either of the drones 10 and/or 100 or combinations thereof. The modular component 300 may be connected to the UAV 200 by physical connections 24 (FIG. 1) and/or power and control connections 26 (FIG. 1). Although depicted coupled to a bottom of the UAV 200, it may be appreciated that the modular component 300 may be coupled to the top or other surface of the UAV 200. Additionally, more than one modular component 300 may be provided. For example, the components of drones 10 and/or 100 of FIGS. 1 and 2 may be stacked to provide one or more cooking areas and delivery areas to accommodate one or more food items and/or customers. In an exemplary embodiment, one or more drones configured to cook a pizza may be included and may be stacked with one or more drones configured to cook other foods.

With the drones 10 and 100 described, operation of the drones 10 and 100 may now be appreciated. For ease of discussion, the drone 10 is referred to, although it may be understood that the procedure may be used for drone 100 as well. Furthermore, for continued ease of discussion, the food item 32 is described as a pizza 32 and the container 34 is described as a pizza box 34, however as previously described, any number of food items 32 may be cooked and delivered in the drone 10. Additionally, for ease of discussion, the drone 10 is described as an unmanned aerial vehicle (UAV), however it is understood that any autonomous vehicle (such as one traveling on land or water) may be employed.

In operation, a customer may place an order for a pizza 32, for example on a computer, smart phone, tablet, or other electronic device, or by telephone. An employee may assemble the pizza 32, e.g. forming the pizza dough, placing sauce, cheese, and requested toppings on the pizza 32. The employee may then open the loading door and place the assembled pizza 32 on the conveyor 30 in the oven 28. Once the pizza 32 is located in the cooking area 14, the employee may close and lock the loading door. The drone 10 may communicate with a computer located at the drone's home location and/or other locations, such as a warehouse or central facility, etc. The computer may communicate the delivery address to the drone 10. Alternatively, the employee may enter the delivery address into the drone 10 through a user interface. The delivery address may be a physical mailing location. Alternatively, the delivery address may be a set of coordinates (e.g. the delivery location could be a place in a park, on a beach, in a boat, etc.). The coordinates may be communicated to the drone 10 by allowing the drone 10 to “see” a customer's location through their location services on their mobile or computing device.

The controller (not depicted) on the drone 10 may evaluate current traffic conditions (e.g., traffic conditions on air, land, and/or water) to determine a time of travel and a course of travel. The controller may also evaluate other factors, such as factors that may affect the speed of travel and thus the delivery time. For example, these factors may include a customer's desired delivery time, weather conditions, cooking time of the food item to be delivered, etc. The controller may also include instructions for cooking the pizza 32. The controller may include programming which compares the factors that affect speed of delivery, such as time of travel, to the cooking time and appropriate cooling time of the pizza 32.

The controller may use an algorithm to determine when the cooking of the pizza 32 begins and when travel to the delivery location is initiated. The algorithm may evaluate the factors which affect delivery of the food item by the drone, such as those factors which affect speed and/or the desired delivery time of the customer. The algorithm may also evaluate the projected cooking and cooling time of the food item. The various factors may be weighted in the algorithm such that some factors are considered more heavily than other factors. The weights may be applied to the factors based on desired functions of the drone and desired customer service.

In some embodiments, the cooking time and the travel time may not be the same. In these instances, the times may be staggered such that flight begins prior to cooking or vice versa. In the event that the times switch during flight, the controller may adjust the cooking time and/or flight time appropriately. For example, if the drone hits traffic that delays delivery, the controller may lower the cooking temperature and/or initiate a warming cycle after cooking to ensure the food remains warm for delivery. The drone may also include sensors configured to monitor the cooking of the food item and sense when the food is cooked (e.g., temperature sensors). In an instance where the sensors determine the food has completed cooking, perhaps earlier than projected, the controller may adjust the speed of the drone and/or initiate a warming cycle to ensure proper delivery of the food item.

For example, in a first situation, the cooking time of the pizza 32 and associated cooling time of the pizza 32 together may be greater than the travel time to the delivery location. In this situation, the controller may turn on the oven to the desired temperature and begin cooking the pizza while the drone 10 is still located at its home location. Once the remaining cooking time and cooling time together is equal to the travel time, the controller may initiate the drone 10 to travel to the delivery location. Thus, it may be appreciated that when the drone 10 arrives at the delivery location, the pizza 32 will be properly cooked and cooled to an eating temperature for the customer.

In a second situation, for example, the cooking time of the pizza 32 and associated cooling time of the pizza 32 together may be less than the travel time to the delivery location. In this situation, the controller may initiate the drone 10 to begin travel to the delivery location. Once the remaining travel time is equal to the cooking time and cooling time together, the controller may turn on the oven to the desired temperature and begin cooking the pizza while the drone 10 is traveling. Again, it may be appreciated that when the drone 10 arrives at the delivery location, the pizza 32 will be properly cooked and cooled to an eating temperature for the customer.

In a third situation, for example, the cooking time of the pizza 32 and associated cooling time of the pizza 32 together may equal to the travel time to the delivery location. In this situation, the controller may initiate the drone 10 to begin travel to the delivery location simultaneously or substantially simultaneously with turning on the oven to the desired temperature and begin cooking the pizza while the drone 10 is traveling. Again, it may be appreciated that when the drone 10 arrives at the delivery location, the pizza 32 will be properly cooked and cooled to an eating temperature for the customer.

Alternatively, or additionally, in any of the above described situations the drone 10 may be controlled to add or include a warming status of the oven 28. That is, cooking and travel may be initiated simultaneously, but where the cooking time is shorter than the travel time, or where traffic is encountered which alters the travel time, the warming status may be actuated. The warming status of the oven 28 may allow for the pizza 32 to remain warm until the drone 10 arrives at the delivery location. As mentioned, in any of the three previous situations, traffic, weather, and other unforeseen delays may delay the drone and thus delay the delivery of the food item to the customer. In these instances, the warming cycle may be actuated. Alternatively, the speed of the drone may be accelerated to accommodate faster cook times.

Once the drone 10 has arrived at the delivery location, the controller may turn off the oven (if still on). The controller may then actuate the conveyor to deliver the pizza 32 into the pizza box 34. Once the pizza 32 is in the pizza box 34, the controller may open the delivery door 22 to allow the customer to remove the pizza box 34. In some embodiments, the controller may close the pizza box 34. In other embodiments, the customer may close the pizza box 34 as it is removed from the drone 10. In still another embodiment, the delivery door 22 may be hinged from the top. The force of the pizza 32 moving from the conveyor 30 to the pizza box 34 may push the pizza box 34 against the delivery door 22, thus opening the delivery door 22. The force of the pizza 32 may also move the pizza box 34 out of the delivery door 22. As the pizza box 34 moves out of the delivery door 22, the delivery door 22 may exert a force on the top of the pizza box such that the pizza box is closed as it exits the drone 10. Thus, a closed pizza box 34 is delivered to the customer.

It may be appreciated disclosure that the controller may monitor and control the temperature of the oven 28 (and subsequent delivery to the food container) so that the pizza 32 is fully cooked and hot upon delivery. Thus, any situation which the drone 10 encounters may be corrected for with the controller. In the event the controller cannot resolve a situation, the controller may communicate with its home location and receive instructions for completing the delivery. For example, as mentioned, if there is heavy traffic or other traffic delays, a warming cycle may be initiated or the oven temperature may be lowered. If travel is faster than projected, the warming cycle may be initiated or the customer may be advised delivery is available earlier. If earlier delivery is not desired by the customer, the warming cycle may be initiated until the original delivery time. If the customer is not available at the designated delivery time, the warming cycle may be initiated until the customer is present to accept delivery.

As may further be appreciated, the cooking time and cooking temperature of the pizza 32 may be programmed into the controller. The cooking time and cooking temperature may be determined based on the configuration of the pizza. Exemplary cooking times and temperatures are provided in Table 1. The controller may use the above described algorithm to ensure the pizza 32 arrives at the moment cooking is completed and the pizza is cooled to the ideal state. As mentioned the controller may factor in additional conditions, such as weather, traffic, accidents, unforeseen delays, etc. When a delay occurs, the drone 10 may be controlled to go into the warming mode, where the pizza is baked, but the drone has yet to arrive at the delivery location. Otherwise, the normal cooking cycle will include a warm down period to ensure the fresh pizza is safe to handle and/or consume at the designated arrival time.

TABLE 1
Exemplary cooking times and temperatures

| Pizza Type | Cooking Time | Cooking Temperature |
|---|---|---|
| Plain | 20 minutes | 350° F. |
| Plain | 25 minutes | 300° F. |
| Pepperoni | 22 minutes | 350° F. |
| Pepperoni | 29 minutes | 300° F. |
| Supreme (Everything) | 25 minutes | 350° F. |
| Supreme (Everything) | 32 minutes | 300° F. |

In an alternative embodiment, the drone 10 may be preloaded with a food item 32 or one or more ingredients to make the food item 32, such as a pizza 32. Once preloaded, the drone 10 may be placed in a communal location where a customer may access the drone 10, similar to a vending machine. The drone 10 may include a user interface. The customer may enter their order into the user interface. The drone 10 may assemble the pizza, cook the pizza, and then deliver the pizza to the customer at the current location. Alternatively, the drone 10 may assemble and cook the pizza during flight to another location entered into the user interface by the customer.

In another embodiment, the customer may be remote and enter the order into a smart device (e.g. cell phone, smart phone, tablet, computer) which may communicate (e.g. by Bluetooth® or other short-link radio technology) with the drone 10. The drone 10 may be programmed and equipped to accept payment for the food item. The controller may be programmed with blockchain technology to provide a secure transaction for the customer to pay for the food item. The drone 10 may then assemble and cook the pizza during flight to the customer's remote location.

The controller on the drone 10 may turn on the oven and cook the food item 32, as previously described. The customer may wait at the drone 10 for the food item 32 to be cooked. Alternatively, the customer may enter in an address for delivery when entering in their food order. The customer may leave and the drone may use the aforementioned algorithm to cook the food item 32 during transit to the customer's delivery address, as previously described. In this manner, the drone 10 may be wholly autonomous.

In any of the foregoing examples, the process of loading, preparing, cooking, and delivering the food item may be tracked using blockchain technology. For example, at each step along the process, a block may be created to track and monitor the cooking and delivering process. In an exemplary embodiment, a block may be created when the order is placed, another block may be created when the ingredients are loaded into the drone, another block may be created when the cooking time begins, another block may be created when the drone beings to travel, a block may be created while the drone is in transit, a block may be created when the drone arrives at the delivery location, and/or a block may be created when the food item is delivered to the customer. In this manner, both the employee and the customer may track the food item along its journey from order to delivery. In addition, the blockchain may be used to verify if a particular vehicle is able to make and deliver the item. For example, the blockchain can verify if a particular vehicle has hot peppers to place on the pizza, or to locate a vehicle that does.

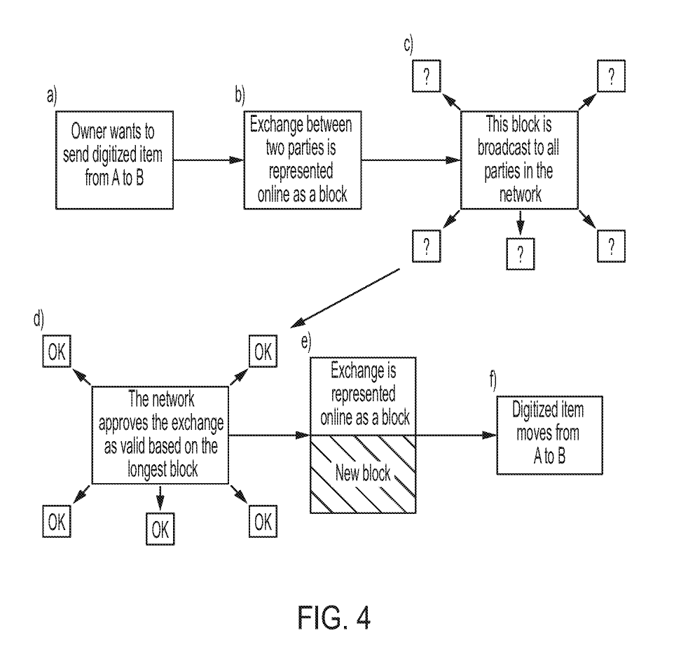

Referring to FIG. 4, described is a peer-to-peer authentication system which may be employed in any of the previously described embodiments. The peer-to-peer authentication system of FIG. 4 is for valuable digitized items (a) that allows online interactions directly between two or more parties without going through one or more trusted intermediaries (b). A peer-to-peer network (c) timestamps actions, hashing them into an ongoing chain of hash-based proof-of-work code to form a record that cannot be changed without redoing the proof-of-work. The longest chain distributed on the peer-to-peer network proves that the data must have existed at the time in order to get into the hash (d), thereby proving the sequence of events witnessed, thereby proving the integrity of the digitized document has been maintained. A new block is added, creating a new chain (e) that now becomes the longest block and the digitized content is moved to the receiving party (f). In an exemplary embodiment, the authentication system utilizes one or more aspects of conventional blockchain systems such as, for example, those disclosed in US Patent Application 20160098723 and 20160098730, the disclosures of which are incorporated herein by reference in their entirety.

The system allows digitized item use as intended based on cryptographic proof instead of trust, allowing any two or more willing parties to employ the content without the need to trust each other and without the need for a trusted third party.

Although the foregoing description is directed to the preferred embodiments of the invention, it is noted that other variations and modifications will be apparent to those skilled in the art and may be made without departing from the spirit or scope of the invention. Moreover, features described in connection with one embodiment of the invention may be used in conjunction with other embodiments, even if not explicitly stated above.

1. An unmanned vehicle for cooking and delivering food, the unmanned vehicle comprising:
a housing;
an oven inside the housing, the oven having at least one heating element;
a conveyor inside the oven, the conveyor configured to support food;
a tambour door coupled between the oven and a delivery area of the housing;
a box in the delivery area, the box configured to hold cooked food;
wherein the conveyor is configured to move the cooked food from the oven to the box in the delivery area of the housing; and
a delivery door configured to seal the delivery area from an area outside of the housing, wherein the oven is configured to cook food during a delivery time of the unmanned vehicle, and wherein the unmanned vehicle is configured to deliver the food to a delivery location;
wherein a force of the cooked food entering the box from the conveyor opens the delivery door to move the box from the delivery area of the housing to the delivery location.

2. The unmanned vehicle of claim 1, wherein the delivery door is coupled to the housing with a hinge at a top of the delivery door.

3. (canceled)

4. (canceled)

5. (canceled)

6. The unmanned vehicle of claim 1, wherein the delivery door closes a lid of the box while the box is moving from the delivery area of the housing to the delivery location.

7. The unmanned vehicle of claim 1, further comprising a loading door, the loading door located between the area outside of the housing and the oven to allow for loading of food into the oven.

8. The unmanned vehicle of claim 7, wherein the loading door includes a lock.

9. The unmanned vehicle of claim 1, the at least one heating element comprising a first heating element and a second heating element, wherein the first heating element is located on an upper interior surface of the oven and the second heating element is located on a lower interior surface of the oven.

10. The unmanned vehicle of claim 9, wherein the second heating element is located below the conveyor.

11. The unmanned vehicle of claim 1, further comprising:
a second housing;
a second oven inside the second housing, the second oven having at least one second heating element;
a second conveyor inside the second oven, the second conveyor configured to support food;
a second tambour door coupled between the second oven and a second delivery area of the second housing; and
a second delivery door configured to seal the second delivery area from the area outside of the housing,
wherein the second housing is aligned with the housing and coupled to an upper outer surface of the housing thereby allowing the unmanned vehicle to be adapted to delivery two cooked foods to the delivery location.

12. A method for cooking food during aerial transport of the food, the method comprising:
providing an unmanned aerial vehicle, the unmanned aerial vehicle having a housing comprising an oven and a delivery area;
loading a food item into the oven of the unmanned aerial vehicle at a first location;
navigating the unmanned aerial vehicle to a second location;
cooking the food item in the oven during the navigating to the second location;
landing the unmanned aerial vehicle at the second location;
conveying the food item on a conveyor from the oven to a box in the delivery area;
opening a delivery door of the unmanned aerial vehicle to deliver the box to the second location; and
closing a lid of the box during opening the delivery door of the unmanned aerial vehicle.

13. (canceled)

14. The method of claim 13, wherein the delivery door causes the closing of the lid of the box.

15. The method of claim 12, wherein the conveying the food item on the conveyor from the oven to the box in the delivery area causes the opening of the delivery door.

16. The method of claim 12, further comprising determining a transit time of the unmanned aerial vehicle from the first location to the second location and determining a cooking time for the food item.

17. The method of claim 16, wherein when the cooking time is less than the transit time, beginning to cook the food item when a remaining transit time after launch is equal to the cooking time plus a predetermined cooling time.

18. The method of claim 17, wherein when the cooking time is greater than the transit time, beginning to cook the food item prior to launching the unmanned aerial vehicle and launching the unmanned aerial vehicle when a remaining cooking time is equal to the transit time plus a predetermined cooling time.

19. A method for cooking food during aerial transport of the food, the method comprising:
providing an unmanned aerial vehicle, the unmanned aerial vehicle having a housing comprising an oven and a delivery area;
loading a food item into the oven of the unmanned aerial vehicle at a first location;
navigating the unmanned aerial vehicle to a second location;
determining a transit time of the unmanned aerial vehicle from the first location to the second location;
determining a cooking time for the food item
cooking the food item in the oven during the navigating to the second location, wherein when the cooking time is less than the transit time, beginning to cook the food item when a remaining transit time after launch is equal to the cooking time plus a predetermined cooling time;
landing the unmanned aerial vehicle at the second location;
conveying the food item on a conveyor from the oven to a box in the delivery area; and
opening a delivery door of the unmanned aerial vehicle to deliver the box to the second location.
